(19) United States
(12) Patent Application Publication
(10) Pub. No.: US 2011/0056615 A1
(43) Pub. Date: Mar. 10, 2011

(54) ADHESIVE TAPE JOINING METHOD AND ADHESIVE TAPE JOINING APPARATUS

(76) Inventors: Saburo Miyamoto, Kameyama-shi (JP); Yukitoshi Hase, Kameyama-shi (JP); Masayuki Yamamoto, Osaka (JP)

(21) Appl. No.: 12/861,016

(22) Filed: Aug. 23, 2010

(30) Foreign Application Priority Data
Sep. 9, 2009 (JP) 2009-208122

(51) Int. Cl. B29C 65/50; B32B 37/12; B32B 37/02; B32B 38/00

(52) U.S. Cl. 156/160; 156/204; 156/459

(57) ABSTRACT

A nipper formed of a pair of nip blocks in an open state suction-holds on nip surfaces thereof a front end of the adhesive tape that is folded back with an edge member and separated from a separator. Then, the nip block on a front end side pivots to unite the nip surfaces of the nip blocks to each other. As a result, the adhesive tape is bent inwardly and adhesive layers thereof are adhered to each other to form a tab. The nip block on a rear end side suction-holds a rear end of the cut adhesive tape. Then, the nip block on the rear end side pivots to bend the adhesive tape inwardly for forming a tab.

### BACKGROUND OF THE INVENTION

1. Field of the Invention

This invention relates to adhesive tape joining method and apparatus for joining an adhesive tape to an adherend such as building materials including a long object and a large panel or a corrugated board. More particularly, this invention is directed to a technique of forming tabs at ends of the adhesive tape to be joined to the adherend.

2. Description of the Related Art

An adhesive tape is joined for protecting a surface of the building panel having a wood-grain or marble tone, etc., protecting a surface for eliminating contamination of a joint, and adhering a flap in assembly of the corrugated board. The adhesive tape is finally to be separated from the adherend.

The adhesive tape joined to the adherend forms a tab so as to fold back a front end of the adhesive tape inwardly to join the adhesive layers to each other for improved separating efficiently. That is, picking this tab may result in easier separation of the adhesive tape from the adherend. See Japanese Patent Publication No. 2002-20027.

In the conventional method of joining the adhesive tape, however, the tab can be formed only at a front end of the adhesive tape in a tape supply direction.

Where the adherend is a long object and the adhesive tape can be separated only in one direction of longitudinal directions, a direction of the adherend to be set in the device needs to be aligned in advance. In such condition, where the adherend is included that has a reverse set direction, a disadvantage occurs that the long object with difficulty in turning has to be reversed backward and forward.

Moreover, the adhesive tape sometimes has a tab only at one end thereof although the adhesive tape may be separated from any end of the long object in the longitudinal direction. Here, separating of the adhesive tape is inflexible, which leads to a disadvantage of reduction in working efficiency.

### SUMMARY OF THE INVENTION

This invention has one object to allow joining of the adhesive tape having tabs formed at any end thereof regardless of a tape joining direction in joining the adhesive tape to an adherend.

Additional features of the invention will be set forth in the description which follows, and in part will be apparent from the description, or may be learned by practice of the invention.

This invention discloses a method of joining an adhesive tape to an adherend, including the steps of forming a front tab by folding back a front end of the adhesive tape, joining the adhesive tape having the tab formed thereon to a joining portion of the adherend, cutting the adhesive tape upstream from a rear end of the joining portion, and forming a rear tab by folding back a rear end of the cut adhesive tape. Here, the tab is controlled as to form on at least one of the front and rear ends.

According to the method of joining the adhesive tape, the tab may be formed on at least one of the front and rear ends regardless of the joining direction of the adhesive tape.

In the foregoing method, the step of forming the front tab preferably includes suction-holding a non-adhesive face of the adhesive tape while opening a pair of nip members that pivots about an axis on a proximal end thereof, and pivoting the nip member that suction-holds the adhesive tape on the tip end thereof and folding back the adhesive tape inwardly to join adhesive layers of the adhesive tape to each other that is suction-held on the other nip member for formation of the tab. Moreover, the step of forming the rear tab preferably includes suction-holding a non-adhesive face of the cut adhesive tape while opening the nip members, and pivoting the nip member that suction-holds the adhesive tape on the rear end thereof and folding back the adhesive tape inwardly to join the adhesive layers of the adhesive tape that is suction-held on the other nip member for formation of the tab.

In addition, the method preferably includes pressing a first joining roller against the adhesive tape to join the adhesive tape to the adherend to a given position immediately before where joining of the adhesive tape is to be completed, pressing a second joining roller that is arranged downstream from the first joining roller against the adhesive tape in the given position, applying a tension to the adhesive tape between an edge member that separates the adhesive tape from a separator and the second joining roller, suction-holding the adhesive tape on nip surfaces of the nip members, cutting an upstream of the suction-held adhesive tape with a cutter, folding back the upstream of the cut adhesive tape with the nip members to join and adhere the adhesion layers of the adhesive tape to each other, and pressing the second joining roller against the adhesive tape from a portion on the second joining roller to the tab.

This invention also discloses an adhesive tape joining device that joins an adhesive tape to an adherend. The device includes a holding mechanism, a tape supply mechanism, a tape cutting mechanism, a tab forming mechanism, a first joining roller, a second joining roller, and a nip mechanism. The holding mechanism holds the adherend. The tape supply mechanism supplies the adhesive tape toward a joining portion of the adherend. The tape cutting mechanism cuts the adhesive tape that is supplied on the joining portion. The tab forming mechanism with a pair of nip members that pivots about an axis on a proximal end and suction-holds a non-adhesive surface of the adhesive tape pivots the nip member that suction-holds the adhesive tape on an end thereof and fold back the adhesive tape inwardly for formation of a tab on the end of the adhesive tape. The first joining roller that is arranged upstream of the tab forming mechanism presses the adhesive tape having the tab formed on a front end thereof to join the adhesive tape to the adherend. The second joining roller that is arranged downstream of the tab forming mechanism presses the adhesive tape instead of the first joining roller in cutting of the adhesive tape, and presses the cut adhesive tape having the tab formed on a rear end thereof to join the adhesive tape to the adherend. The nip mechanism nips the adhesive tape upstream of the first joining roller in the cutting of the adhesive tape.

With this configuration, the nip member of the tab forming mechanism suction-holds the front end of the adhesive tape and the nip member on the front end side pivots to fold back the adhesive tape inwardly, thereby forming a tab on the front end of the adhesive tape.

The first joining roller presses the adhesive tape while keeping supply of the adhesive tape having the tab formed thereon, whereby the adhesive tape may be joined to the joining portion of the adherend. When accessing a rear end of the joining portion, the second joining roller instead of the first joining roller presses the adhesive tape. Simultaneously, the nip members nip the adhesive tape. As a result, the adhesive tape may be held upstream and downstream across the tab forming mechanism.

The non-adhesive face of the adhesive tape is suction-held with the nip members in such a state to be cut on the rear end side thereof. After cutting of the adhesive tape, the holder on the rear end side pivots to fold back the adhesive tape inwardly, thereby forming the tab on the rear end of the adhesive tape.

After formation of the tab, the second joining roller rolls, thereby joining the adhesive tape to the joining portion between downstream of the tab and the tab. With this configuration, the foregoing method may suitably be performed.

Here, the adhesive tape has a separator joined thereto. A separator collecting section is provided that collects the separator separated from the adhesive tape. The nip mechanism includes an edge member that reverses the adhesive tape, and a pressure roller that presses the adhesive tape against the tip end of the edge member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a front view showing an adhesive tape joining apparatus.

FIGS. 2 to 10 show basic operations of joining an adhesive tape in forming tabs.

FIG. 11 shows an adhesive tape having tabs formed on both ends thereof.

FIG. 12 is a front view of joining the adhesive tape having tabs.

FIGS. 13 to 15 show basic operations of joining an adhesive tape having no tab.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One embodiment of this invention will be described hereunder with reference to the drawings.

In the exemplary embodiment, method and apparatus will be described for joining an adhesive tape to a large and thin building panel while forming tabs on both ends of the adhesive tape. However, the method and apparatus are not limited to this exemplary embodiment. For instance, the method and apparatus are also applicable to joining of the adhesive tape to various large or long adherends rather than a building panel.

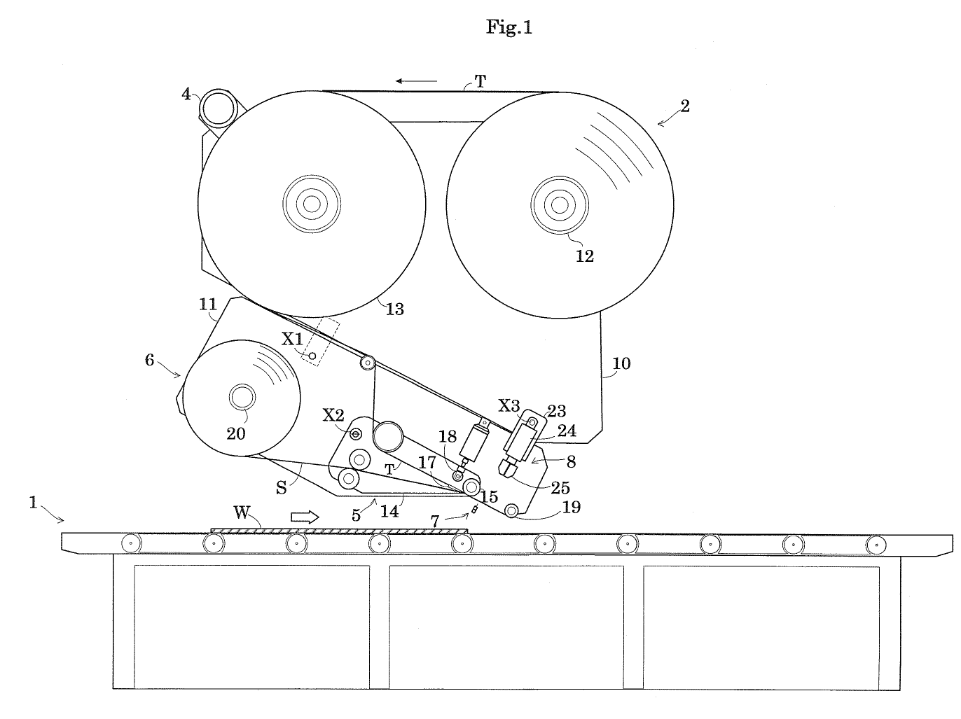

FIG. 1 is a front view of an adhesive tape joining apparatus.

The adhesive tape joining apparatus has a panel transport mechanism 1, a tape supply mechanism 2, a detector 4, a tape joining mechanism 5, a separator collecting section 6, a tape cutting mechanism 7, and a tab forming mechansim 8. The panel transport mechanism 1 mounts and transports a building panel W as an adherend on a transportation path. The tape supply mechanism 2 supplies an adhesive tape T to the building panel W on the transportation path. The detector 4 detects a feeding length of the adhesive tape T. The tape joining mechanism 5 joins the adhesive tape T to the building panel W on the transportation path. The separator collecting section 6 separates and collects a separator S from the adhesive tape T. The tape cutting mechanism 7 cuts the adhesive tape T by a predetermined length. The tab forming mechanism 8 forms tabs on ends of the adhesive tape T. Here, the tape joining apparatus has a wall 10 on the back thereof that is placed vertically. The tape supply mechanism 2, the detector 4, the tab forming mechanism 8, and a turn roller 13 that is to be mentioned later are arranged on the wall 10. The tape joining mechanism 5 and the separator collecting section 6 are pivotally supported to a connector on the wall 10, and placed on a bracket 11 pivotable about an axis X1. Hereinafter, description will be given to detailed configurations of each component and mechanism.

The panel transport mechanism 1 is formed of a roller conveyor that suction-holds and transports a rear face of the building panel W.

The tape supply mechanism 2 has the following configuration. That is, the adhesive tape T provided with the separator S is fed out from a supply bobbin 12, and then is wound up by the turn roller 13 to be guided to the tape joining mechanism 5.

Here, the supply bobbin 12 is applied with appropriate resistance against its rotation in order to prevent the adhesive tape T from being fed out excessively.

The turn roller 13 controls a feeding length of the adhesive tape T in accordance with a unit length of the tape joining portion in an adherend such as the building panel W. Accordingly, a diameter of the turn roller 13 is properly variable depending on tape joining conditions, e.g., an adherend.

The detector 4 is formed of a rotary encoder, etc., and detects the length of the adhesive tape T to be supplied. In this embodiment, the detector 4 detects the length of the joining portion of the building panel W and the length of the adhesive tape T required to form the tabs as a unit.

The tape joining mechanism 5 has a first joining roller 15, an edge member 17, a pressure roller 18, and a second joining roller 19. The first joining roller 15 is pivotally supported at a forward end of a bracket 14 so as to freely rotate. The bracket 14 is pivotally supported by the bracket 11 and is pivotable about an axis X2. The edge member 17 folds back to reverse the separator S arranged upstream of the first joining roller 15, and guides the separator S to the separator collecting section 6 via the pressure roller 18. The pressure roller 18 nips the adhesive tape T so as to cooperate with the edge member 17. The second joining roller 19 is pivotally supported at a lower end of the bracket 11 so as to freely rotate.

The pressure roller 18 is formed so as to move vertically by an actuator, such as a cylinder.

The separator collecting section 6 has the following configuration. That is, a collection bobbin 20 is driven to rotate in a winding direction in order to wind up the separator S separated from the adhesive tape T.

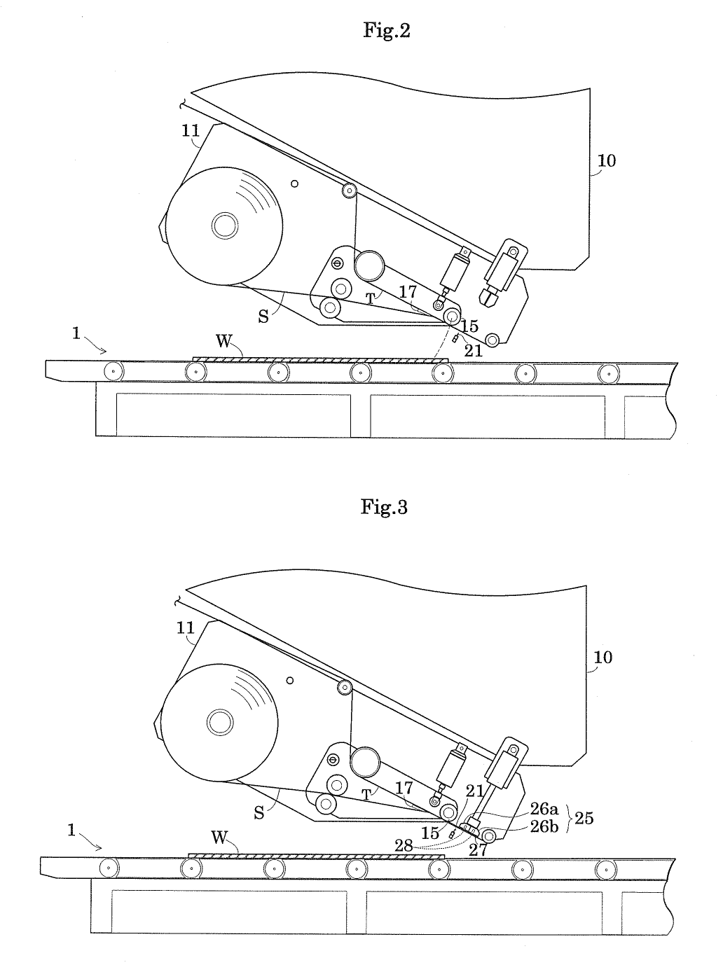

As shown in FIG. 2, the tape cutting mechanism 7 has a cutter holder. The cutter holder has a cutter blade 21 with an edge thereof being directed upward. The cutter blade 21 moves backward and forward from a standby position to a cutting position. Here the standby position is back of the apparatus from the tape cutting mechanism 7. In the cutting position, the adhesive tape T is to be cut. The cutter blade 21 also moves vertically in the operation position. Upon cutting of the adhesive tape T, an angle of the cutter blade 21 is adjusted so as to be perpendicular to the adhesive tape T.

As shown in FIG. 1, the tab forming mechanism 8 has a nipper 25 at an end of a cylinder 24. The cylinder 24 is pivotally supported on the wall 10 via a bracket 23 and pivotable about an axis X3.

As shown in FIG. 3, the nipper 25 has a pair of nip blocks 26a and 26b that are pivotally supported at the proximal end thereof. Each of the nip blocks 26a and 26b has a nip surface 27 with a suction hole 28 formed therein. The suction hole 28 is in communication with a suction device.

Next, description will be made of a basic operation of the foregoing adhesive tape joining apparatus to join an adhesive tape T to a building panel W with referring to FIGS. 2 to 8.

A sensor detects the building panel W transported by the panel transport mechanism 1. The panel transport mechanism 1 once stops when a front end of the building panel reaches a joining position as shown in FIG. 2.

The tab forming mechanism 8 operates as the building panel W stops. Firstly, the tab forming mechanism 8 moves the nipper 25 downward between first and second joining rollers 15 and 19, and opens the nip blocks 26a and 26b. Here, the nip blocks 26a and 26b are opened such that the nip surfaces 27 may be approximately flat.

The front end of the adhesive tape T is fed below the nip blocks 26a and 26b that are open with the holding surfaces 27 directed downward while the edge member 17 separates the separator S. Here, as shown in FIG. 3, the suction device operates to suction-hold the front end of the adhesive tape T with the nip surfaces 27 of the nip blocks 26a and 26b.

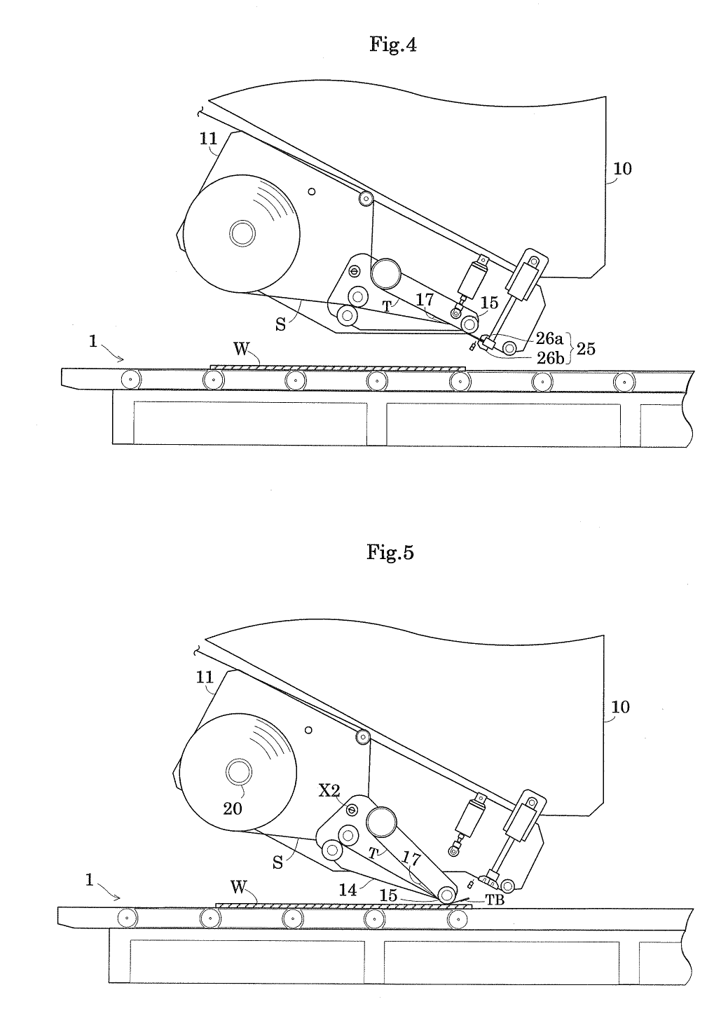

As shown in FIG. 4, upon completion of suction-holding the front end of the adhesive tape T, the nip block 26b pivots to unite the nip surface 27 of the nip block 26b with that of the nip block 26a. Here, the front end of the adhesive tape T is folded back inwardly with the nip block 26b to join the adhesive layers to each other. Consequently, the tab TB is formed on the front end of the adhesive tape, as shown in FIG. 5.

The nip blocks 26a and 26b are opened after formation of the tab TB to release nipping of the tab TB. Thereafter, the bracket 14 swings downward. Here, the front end of the adhesive tape T with the separator S separated therefrom by the edge member 17 is located below the first joining roller 15. Accordingly, the joining roller 15 moves downward to press the adhesive tape T against the joining portion of the building panel W.

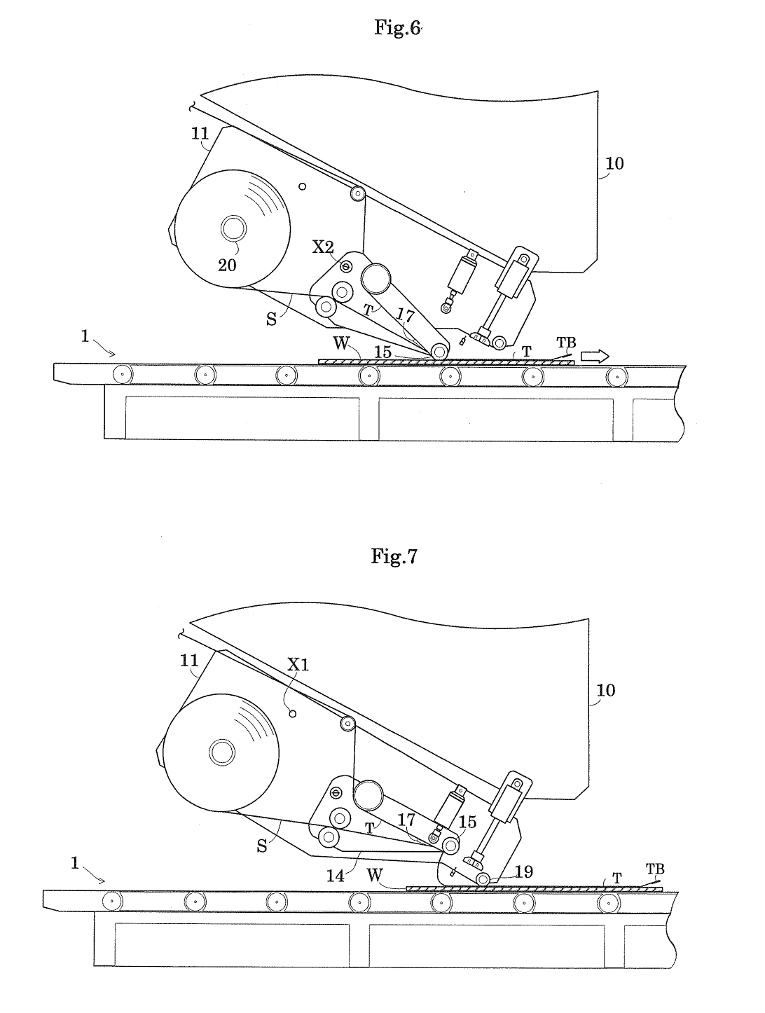

After completion of pressing the front end of the adhesive tape, the panel transport mechanism 1 operates to transport the building panel W in a transport direction, as shown in FIG. 6. With this operation, the first joining roller 15 rolls while applying suitable pressure to the adhesive tape T to join the adhesive tape T to the joining portion.

When the first joining roller 15 reaches a terminal position of the joining portion, transportation of the building panel W stops. With stopping of the transportation, the bracket 14 swings upward into a predetermined level thereof to release pressing of the first joining roller 15 against the adhesive tape T, as shown in FIG. 7. Simultaneously, the bracket 11 swings downward. Here, the second joining roller 19 presses the adhesive tape T to the joining portion downstream of the tab forming mechanism 8.

The pressure roller 18 moves downward as the bracket 14 moves upward to nip the adhesive tape T with the tip end of the edge member 17. In this state, the building panel W slightly moves downstream to apply tension to the adhesive tape T.

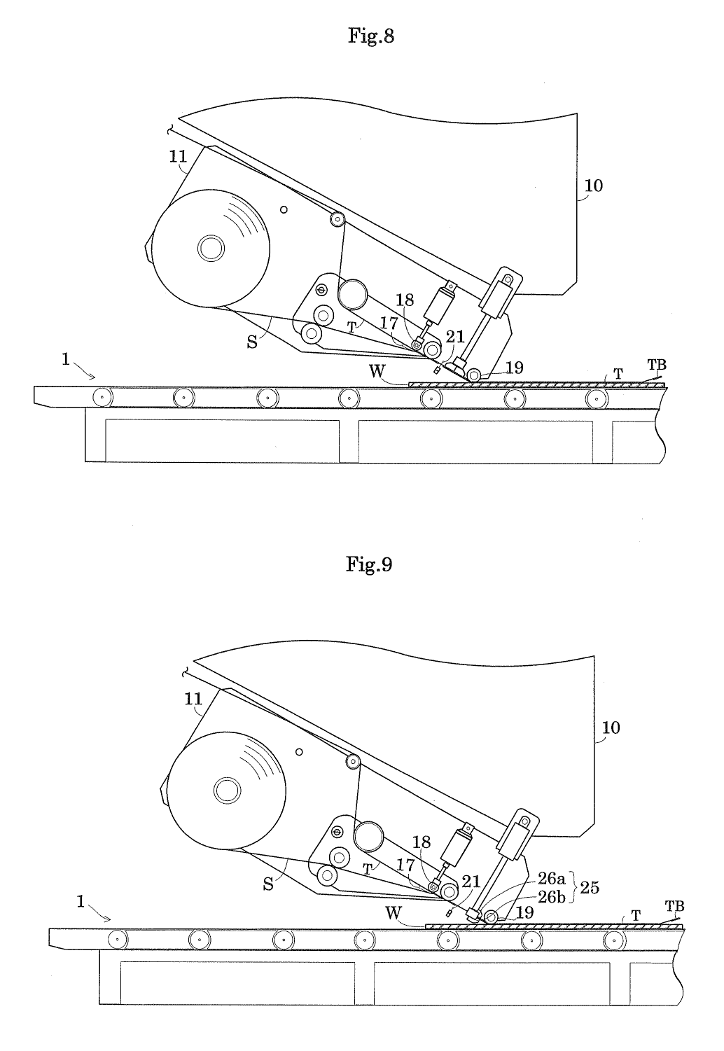

As shown in FIG. 8, the nipper 25 moves downward to a position of the adhesive tape T where tension is applied between the tip end of the edge member 17 and the second roller 19. Thereafter, the nipper 25 suction-holds the non-adhesive face of the adhesive tape T with the nip surfaces 27 of the nip blocks 26a and 26b that are in an open state.

In this state, the cutter blade 21 moves into a cutting position below the adhesive tape T. When reaching to the cutting position, the cutter blade 21 moves upward to pierce the adhesive tape T with the tip end of the cutter blade for cutting the adhesive tape T. Upon completion of cutting the adhesive tape T, the cutter blade 21 moves downward and backward to return to its standby position.

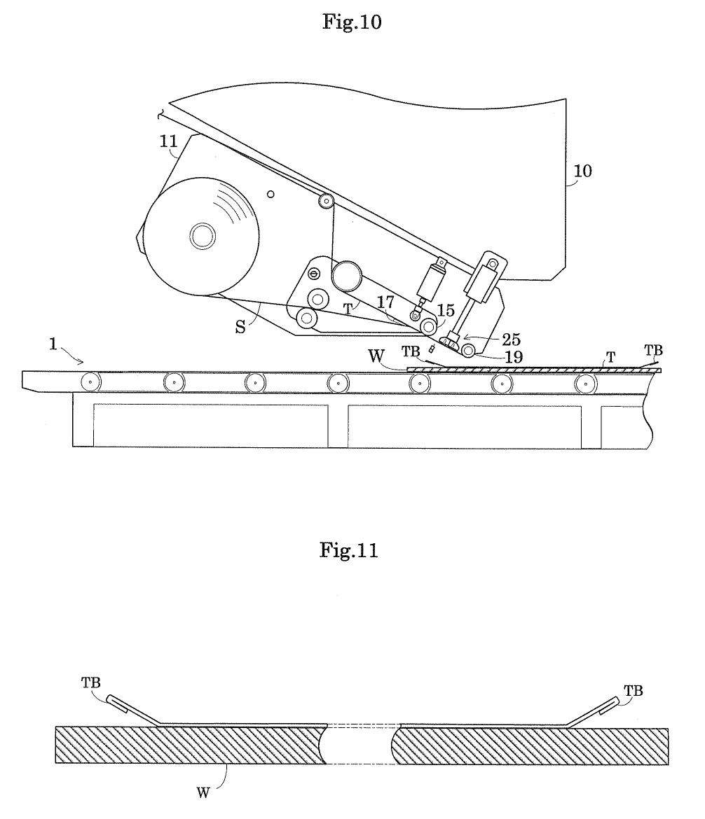

As shown in FIG. 9, the nip block 26a that suction-holds the rear end of the adhesive tape T pivots to unite the nip surfaces 27 of the nip blocks 26a and 26b. Here, the nip block 26a folds back the rear end of the adhesive tape T inwardly to adhere the adhesive layers to each other. Consequently, the tab TB shown in FIGS. 10 and 11 may be formed.

Upon completion of forming the tab TB, the nip blocks 26a and 26b are opened to release nipping of the tab TB. In addition, the second joining roller 19 swings upward to return to its standby position, and only the building panel W is transported downstream, as shown in FIG. 2.

As mentioned above, a basic operation of joining the adhesive tape with the tab TB formed on both ends thereof is completed. Subsequently, the same process as above is to be repeated.

Next, an operation is to be described of joining the adhesive tape T to the adherend with no tab formed on the end of the adhesive tape T.

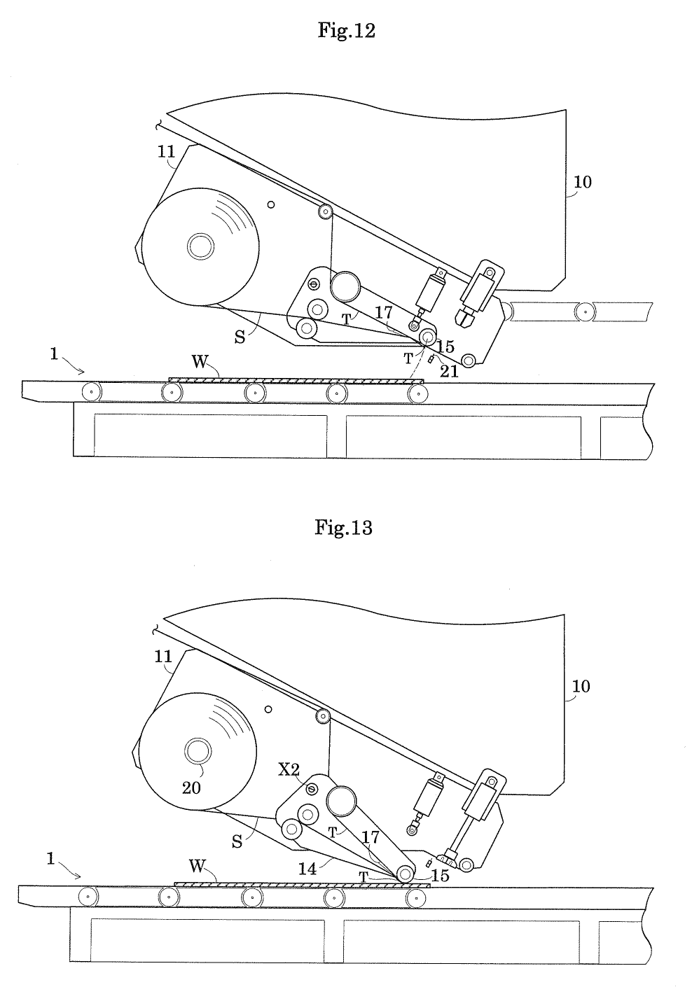

A sensor detects the building panel W transported by the panel transport mechanism 1. The panel transport mechanism 1 once stops when a front end of the building panel W reaches a joining position as shown in FIG. 12.

The separator S is separated from the front end of the adhesive tape T with the edge member 17, and fed out below the first joining roller 15, as shown in FIG. 12.

Upon reaching of the front end of the adhesive tape T below the first joining roller 15, the bracket 14 pivots about an axis X2 to move the first joining roller downward, as shown in FIG. 13. The adhesive tape T is pressed to the joining portion of the building panel W with this downward movement.

After completion of pressing the front end of the adhesive tape, the panel transport mechanism 1 operates to transport the building panel W in a transport direction.

With this operation, the first joining roller 15 rolls while applying suitable pressure to the adhesive tape T to join the adhesive tape T to the joining portion.

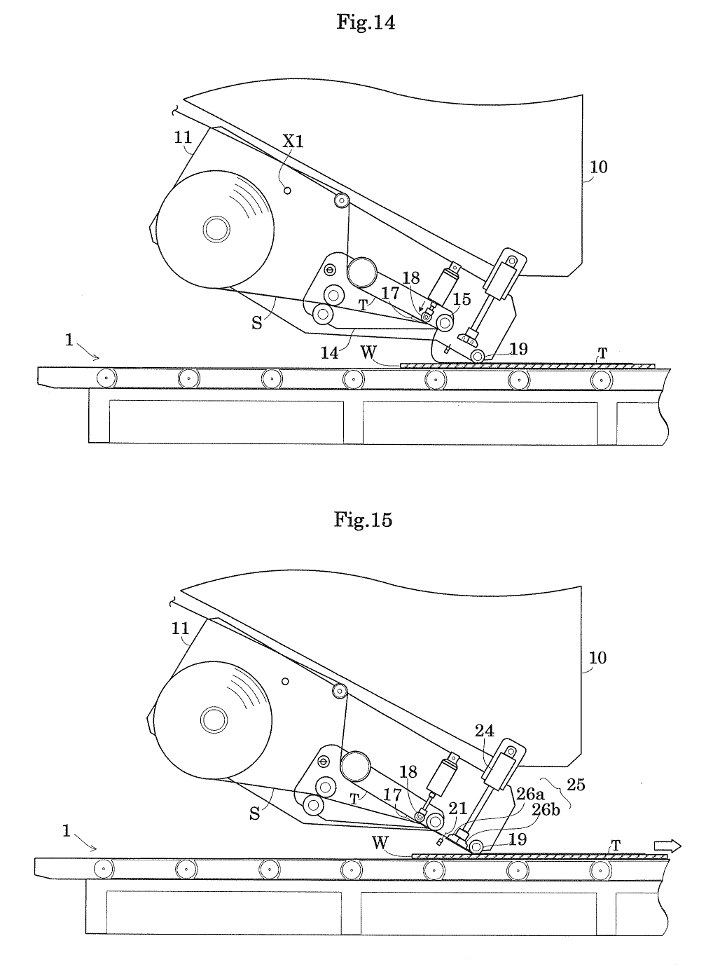

When reaching to a terminal position of the joining portion, the first joining roller 15 stops transportation of the building panel W. With stopping of the transportation, the bracket 14 swings upward into a predetermined level thereof to release pressing of the first joining roller 15 against the adhesive tape T, as shown in FIG. 14. Simultaneously, the bracket 11 swings downward. Here, the second joining roller 19 presses the adhesive tape to the joining portion downstream of the tab forming mechanism 8.

The pressure roller 18 moves downward while the bracket 14 moves upward to nip the adhesive tape T with the tip end of the edge member 17. In this state, the building panel W slightly moves downstream to apply tension to the adhesive tape T.

As shown in FIG. 15, the nipper 25 moves downward to a position of the adhesive tape where tension is applied between the tip end of the edge member 17 and the second roller 19. Thereafter, the nipper 25 suction-holds the non-adhesive face of the adhesive tape T with the nip surfaces 27 of the nip blocks 26a and 26b that are in an open state.

In this state, the cutter blade 21 moves into a cutting position below the adhesive tape T. When reaching to the cutting position, the cutter blade 21 moves upward to pierce the adhesive tape T with the tip end of the cutter blade 21 for cutting the adhesive tape T. Upon completion of cutting the adhesive tape T, the cutter blade 21 moves downward and backward to return to its standby position.

Cutting the adhesive tape T is completed, and the panel transport mechanism 1 operates to transport the building panel W downstream. The nip blocks 26a and 26b have reduced suction force in connection with this transportation. Specifically, as the building panel W is transported downstream, the second joining roller 19 gradually draws the adhesive tape T sucked with the nip blocks 26a and 26b, whereby joining the adhesive tape T to the joining portion of the building panel W.

Upon reaching to the joining termination position, the second joining roller 19 swings upward to return to its standby position. Simultaneously, the building panel W is transported downstream.

As mentioned above, a basic operation of joining the adhesive tape with no tab TB formed on the end thereof to the adherend is completed. Subsequently, the same process as above is to be repeated.

With the adhesive tape joining apparatus, combination of the foregoing embodiments may form the tabs TB on the front and rear ends of the adhesive tape T, and may join the adhesive tape T having no tab TB formed thereon to the building panel W. In other words, the tab TB may be formed on any end of the adhesive tape T.

This invention is not limited to the foregoing embodiment, but may be modified as follows.

In each of the foregoing embodiments, the adhesive tape T may be joined to the adherend while the adhesive tape joining apparatus moves.

In each of the foregoing embodiments where no tab TB is formed, the non-adhesive face of the adhesive tape T is suction-held with the nip blocks 26a and 26b in cutting the rear end of the adhesive tape T. Moreover, the non-adhesive face of the adhesive tape T is kept suction-held until completion of joining the cut adhesive tape T. Such joining forms, however, are not limitative.

For instance, where the second joining roller has a shorter distance to the pressure roller 18 and may contact the cut adhesive tape T to the joining portion with no occurrence of wrinkles in the adhesive tape T, it is not necessary to utilize nipping function of the nip blocks 26a and 26b.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of joining an adhesive tape to an adherend, comprising the steps of:
forming a front tab by folding back a front end of the adhesive tape;
joining the adhesive tape having the tab formed thereon to a joining portion of the adherend;
cutting the adhesive tape upstream from a rear end of the joining portion; and
forming a rear tab by folding back a rear end of the cut adhesive tape,
the tab being controlled as to form on at least one of the front and rear ends.

2. The method of joining the adhesive tape according to claim 1, wherein
the step of forming the front tab further comprises
suction-holding a non-adhesive face of the adhesive tape while opening a pair of nip members that pivots about an axis on a proximal end thereof, and
pivoting the nip member that suction-holds the adhesive tape on the tip end thereof and folding back the adhesive tape inwardly to join adhesive layers of the adhesive tape to each other that is suction-held on the other nip member for formation of the tab; and
the step of forming the rear tab further comprises
suction-holding a non-adhesive face of the cut adhesive tape while opening the nip members, and
pivoting the nip member that suction-holds the adhesive tape on the rear end thereof and folding back the adhesive tape inwardly to join the adhesive layers of the adhesive tape that is suction-held on the other nip member for formation of the tab.

3. The method of joining the adhesive tape according to claim 2, wherein
the step of joining the front tab comprises
pressing a first joining roller against the adhesive tape to join the adhesive tape to the adherend to a given position immediately before where joining of the adhesive tape is to be completed,
pressing a second joining roller that is arranged downstream from the first joining roller against the adhesive tape in the given position,
applying a tension to the adhesive tape between an edge member that separates the adhesive tape from a separator and the second joining roller,
suction-holding the adhesive tape on nip surfaces of the nip members,
cutting an upstream of the suction-held adhesive tape with a cutter,
folding back the upstream of the cut adhesive tape with the nip members to join and adhere the adhesion layers of the adhesive tape to each other, and
pressing the second joining roller against the adhesive tape from a portion on the second joining roller to the tab.

4. The method of joining the adhesive tape according to claim 1, wherein
the adhesive tape is joined to the adherend while the transportation mechanism moves the adherend.

5. An adhesive tape joining apparatus for joining an adhesive tape to an adherend, comprising:
a holding mechanism that holds the adherend;
a tape supply mechanism that supplies the adhesive tape toward a joining portion of the adherend;
a tape cutting mechanism that cuts the adhesive tape that is supplied on the joining portion;
a tab forming mechanism, with a pair of nip members pivoting about an axis on a proximal end and suction-holds a non-adhesive surface of the adhesive tape, that pivots the nip member that suction-holds the adhesive tape on an end thereof and folds back the adhesive tape inwardly for formation of a tab on the end of the adhesive tape;
a first joining roller that is arranged upstream of the tab forming mechanism and presses the adhesive tape having the tab formed on a front end thereof to join the adhesive tape to the adherend;
a second joining roller that is arranged downstream of the tab forming mechanism and presses the adhesive tape instead of the first joining roller in cutting of the adhesive tape, and presses the cut adhesive tape having the tab formed on a rear end thereof to join the adhesive tape to the adherend; and
a nip mechanism that nips the adhesive tape upstream of the first joining roller in the cutting of the adhesive tape.

6. The adhesive tape joining apparatus according to claim 5, wherein
the adhesive tape has a separator joined thereto, and a separator collecting section is provided that collects the separator separated from the adhesive tape, and
the nip mechanism has an edge member that reverses the adhesive tape, and a pressure roller that presses the adhesive tape against the tip end of the edge member.
